(19) United States
(12) Patent Application Publication
(10) Pub. No.: US 2020/0254288 A1
(43) Pub. Date: Aug. 13, 2020

(54) Dry Material Moving Machine

(71) Applicants: Jack W. Davis, Black Diamond, WA (US); Lilynne H. Davis, Black Diamond, WA (US)

(72) Inventors: Jack W. Davis, Black Diamond, WA (US); Lilynne H. Davis, Black Diamond, WA (US)

(21) Appl. No.: 16/842,674

(22) Filed: Apr. 7, 2020

Related U.S. Application Data
(60) Provisional application No. 62/803,274, filed on Feb. 8, 2019.

(51) Int. Cl. A62C 3/02; A62C 2/04

(52) U.S. Cl. CPC A62C 3/0207; A62C 27/00; A62C 2/04

(57) ABSTRACT

A dry material moving machine system; the dry material moving machine system includes a portable or stationary dry material moving machine including a power unit powering the dry material moving machine and connected to a positive air blower or blowers having an air inlet, an outlet in communication with a delivery line, a dry media hopper including a feeder unit configured to direct dry material to the delivery line, and a hose reel. The delivery line is connected to and in communication with a hose to direct the dry material to a fire in order to suppress and extinguish the fire. The dry material is used to constrict an oxygen supply to bring about fire containment quickly through a smothering effect.

### BACKGROUND OF THE INVENTION

The following includes information that may be useful in understanding the present disclosure. It is not an admission that any of the information provided herein is prior art nor material to the presently described or claimed inventions, nor that any publication or document that is specifically or implicitly referenced is prior art.

### TECHNICAL FIELD

The present invention relates generally to the field of fire-extinguishing methods and means of existing art and more specifically relates to firefighting machines.

### RELATED ART

Fires cause vast amounts of property damage and pose a significant threat to human life. In workspaces and other locations, it is vital to have a quick and effective method, in addition to water, for extinguishing fires suitable for a wide variety of potential conditions. An efficient and effective solution is necessary to reduce damage in the area of the fire, as well as damage caused by water caused by traditional extinguishing methods. A suitable solution is desired.

U.S. Pat. No. 1,277,908 to George T Gillette relates to a fire-extinguishing apparatus. The described fire-extinguishing apparatus provides practical means for putting out a fire by the use of the material. The diatomaceous earth is non-combustible and non-fusible at the ordinary temperatures of incipient conflagrations, and in act, is only subject to fusion at a temperature of about 2900 Fahrenheit, and consists of minute silica air cells that are very light so that large bodies of the same are movable by application of comparatively small power.

### SUMMARY OF THE INVENTION

In view of the foregoing disadvantages inherent in the known fire-extinguishing methods and means art, the present disclosure provides a novel dry material moving machine system. The general purpose of the present disclosure, which will be described subsequently in greater detail, is to provide a device configured to disperse dry extinguishing materials in the area of an active fire to cut off the oxygen supply to the fire.

A dry material moving machine system is disclosed herein. The dry material moving machine system includes a portable or stationary dry material moving machine including a power unit powering the dry material moving machine and connected to a positive air blower having an air inlet, an outlet in communication with a delivery line, a dry media hopper including a feeder unit configured to direct dry material to the delivery line, and a hose reel. The delivery line is connected to and in communication with a hose to direct the dry material to a fire in order to suppress and extinguish the fire. The dry material moving machine uses compressed air to launch the crushed dry or ready-to-use material to a desired area in order to smother a fire. The dry material is used to constrict an oxygen supply to bring about fire containment quickly through a smothering effect.

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and methods of use for the present disclosure, a dry material moving machine system, constructed and operative according to the teachings of the present disclosure.

FIG. 1 is a perspective view of the dry material moving machine system during an ‘in-use’ condition, according to an embodiment of the disclosure.

FIG. 2 is a perspective view of the dry material moving machine system of FIG. 1, according to an embodiment of the present disclosure.

FIG. 3 is a perspective view of the dry material moving machine system of FIG. 1, according to an embodiment of the present disclosure.

FIG. 4 is a perspective view of the dry material moving machine system of FIG. 1, according to an embodiment of the present disclosure.

FIG. 5 is a perspective view of the dry material moving machine system of FIG. 1, according to an embodiment of the present disclosure.

The various embodiments of the present invention will, after this, be described in conjunction with the appended drawings, wherein like designations denote like elements.

### DETAILED DESCRIPTION

As discussed above, embodiments of the present disclosure relate to fire-extinguishing methods and means and, more particularly, to a dry material moving machine system as used to improve the effective use of fire-extinguishing means.

Generally, the dry material moving machine system provides a machine designed to assist in all methods of extinguishing and controlling fires in both mobile and stationary operations. Depending upon the particular embodiment, the apparatus includes components selected from the following: power units, hydraulics, electrical controls, either gas or diesel engines, and electrical motors. In addition to the power units, the system contains other subsystems or components selected from the following: compressors, drive systems, storage units and hoppers, controls and piping, hose reels or media conveying systems, covers and protection for machines, and vehicles or trailers for transportation. Vehicles may transport the machine along with dry fire-extinguishing materials. The apparatus crushes material (such a small size materials) if need be and uses the compressed air to launch and disperse the crushed dry powder or other material to the desired area to smother a fire. This material is designed to constrict the oxygen supply to bring about fire containment quickly through a smothering effect. The apparatus uses a simple design to bring about quick and efficient operation through familiarization and a little training.

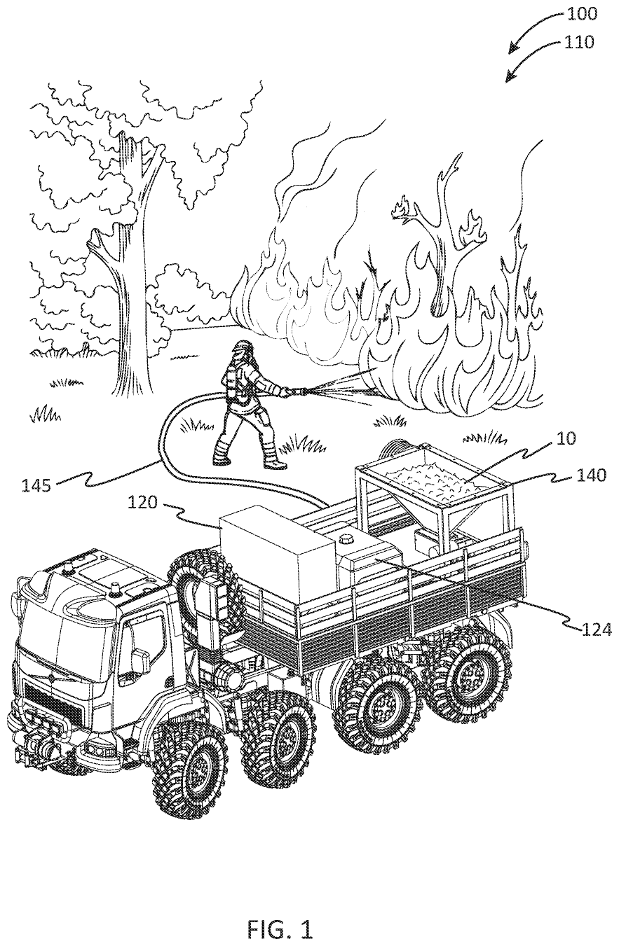

Referring now more specifically to the drawings by numerals of reference, there is shown in FIGS. 1-5, various views of a dry material moving machine system 100.

FIG. 1 shows a dry material moving machine system 100 during an ‘in-use’ condition, according to an embodiment of the present disclosure. Here, the dry material moving machine system 100 may be beneficial for use by a user to disperse dry extinguishing materials 10 in the area of an active fire to cut off the oxygen supply to the fire. As illustrated, the dry material moving machine system 100 may include a dry material moving machine 110 including a power unit 120 connected to a positive air blower 124 having an air inlet 126, an outlet 128 in communication with a delivery line 130, a dry media hopper 140 including a feeder unit 146 configured to direct dry material 10 to the delivery line 130, and a hose reel 144. The delivery line 130 is connected to and in communication with a hose 145 to direct the dry material 10 to a fire to suppress and extinguish the fire.

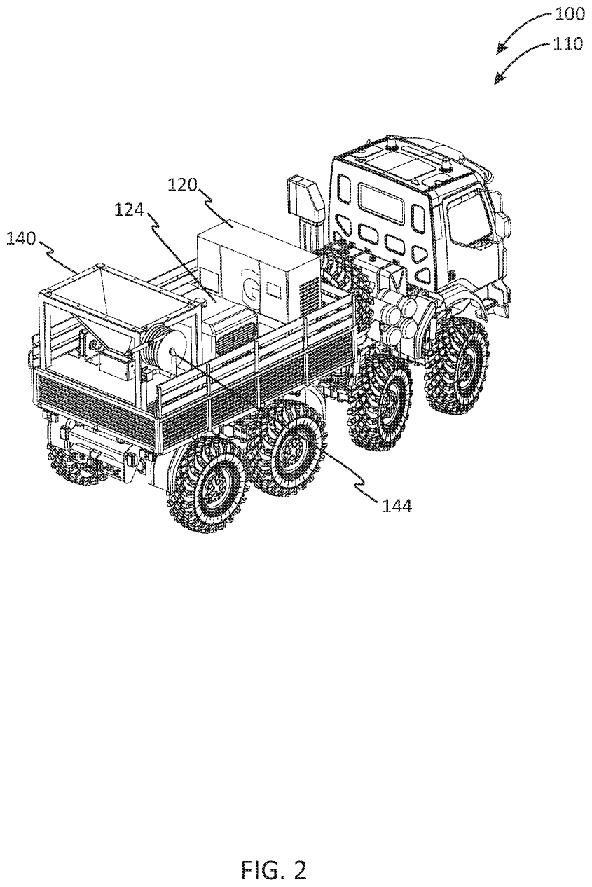

FIG. 2 shows the dry material moving machine system 100 of FIG. 1, according to an embodiment of the present disclosure. As above, the dry material moving machine system 100 may include the dry material moving machine 110 provided to allow many kinds of dry materials 10 to assist with existing systems in fire suppression. The dry material may include soils (including on-site soils), dirt, and dry chemicals. When the dry material moving machine 110 is using on-site soils and dirt, larger particles of the dry material 10 may be crushed and ground by a material crushing mechanism 142 to move through pumps and lines of the dry material moving machine 110. In certain embodiments, the dry material moving machine is portable and may be mounted to a trailer or vehicle for transporting the device. In other embodiments, the dry material moving machine 110 is stationary.

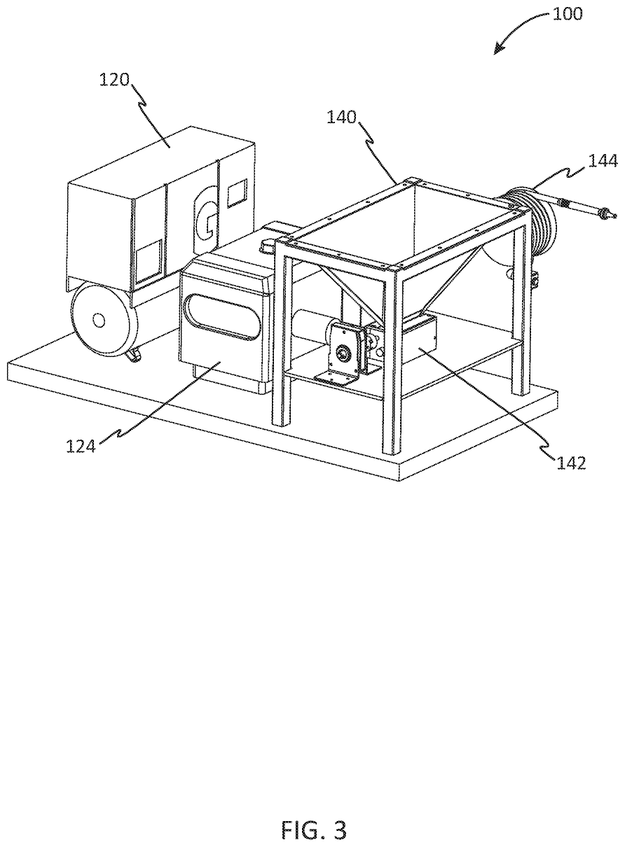

FIG. 3 is a perspective view of the dry material moving machine system 100 of FIG. 1, according to an embodiment of the present disclosure. The dry material moving machine 110 including the power unit 120 powering the dry material moving machine 110 and connected to the positive air blower 124 having the air inlet 126, the outlet 128 in communication with the delivery line 130, the dry media hopper 140 including the feeder unit 146 configured to direct dry material 10 to the delivery line 130, and the hose reel 144. The dry media hopper 140 comprises a dry-material-feeding control valve 160. The dry-material-feeding control valve 160 is positioned between the feeder unit 146 and the delivery line 130. The delivery line 130 and the feeder unit 146 are connected via a tube 162, and the dry-material-feeding control valve 160 is provided on the tube between the delivery line 130 and the feeder unit 146. The delivery line 130 comprises a diameter of 1 inch or greater. The power unit 120 may feature a gas engine, a diesel engine, or an electric motor. The power unit 120 is preferably operable between 700 RPM and 3000 RPM (more or less may be used as needed per application) to the positive air blower 124.

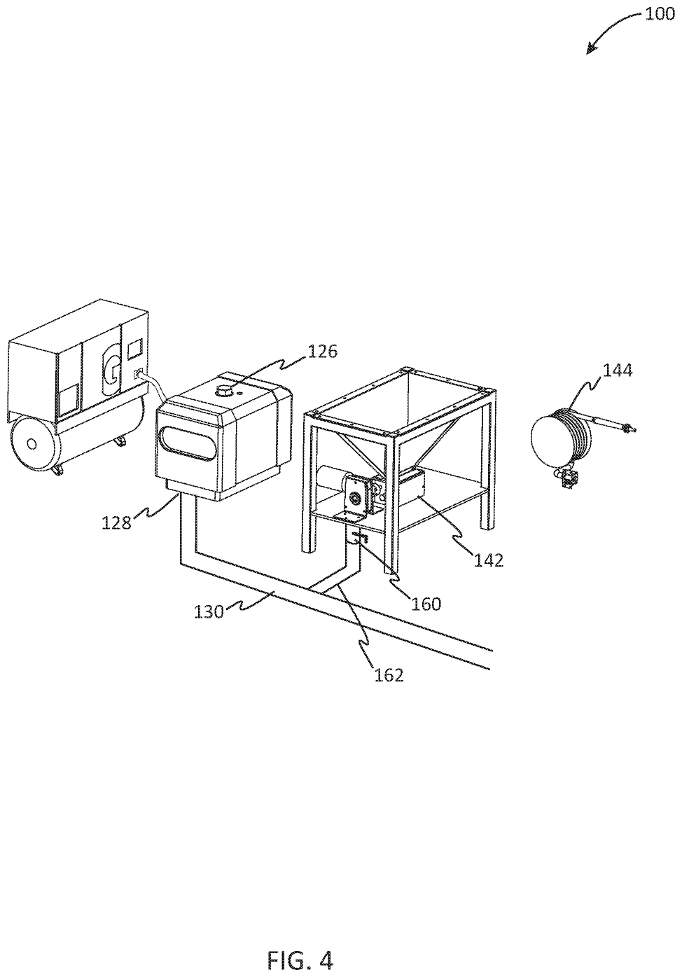

FIG. 4 is a perspective view of the dry material moving machine system 100 of FIG. 1, according to an embodiment of the present disclosure. The dry media hopper or hoppers 140 may be loaded or preloading with the dry materials 10 as needed. Additional storage hoppers may be included, and assorted sizes may be used to accommodate a variety of applications. Various covers 170 may further be included for covering the dry media hopper 140 and storage compartments of the dry material moving machine 110.

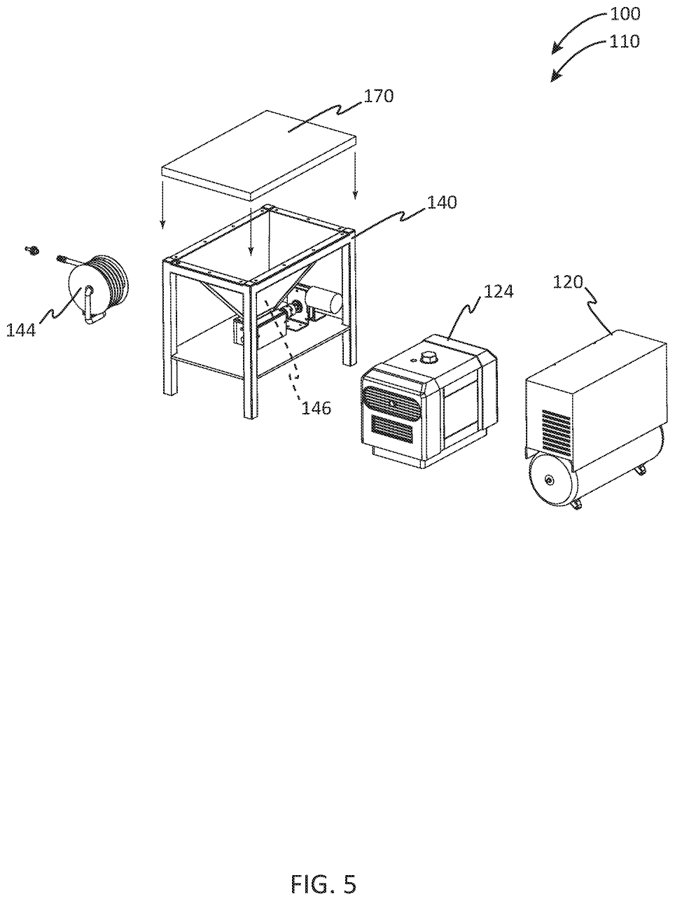

FIG. 5 is a perspective view of the dry material moving machine system 100 of FIG. 1, according to an embodiment of the present disclosure. As previously described, the rigid delivery line 130 is connected to and in communication with the hose to direct the dry material 10 to a fire to suppress and extinguish the fire. The hose 145 is between ½ inch and 4 inches, and the size varies by the particular embodiment of the invention. Other embodiments may employ hoses with diameters larger than 4 inches. The power unit 120 is compatible with the diameter of the hose 145 and is configured to deliver additional power or horsepower as needed to supply sufficient dry material 10. A maximum line pressure of the delivery line 130 is 25 psi in preferred embodiments. Pressures can be changed with each unit to fit applications.

A further advantage of the dry material moving machine can be realized when on-site of a hazmat incident. The dry material can stop flows of hazardous material from leaving the site as a containment barrier. The containment of hazardous liquids on-site has been an issue for years. The dirt or dry powder would help keep our waters safe in many cases if used in conjunction with the existing methods. Additional equipment may be added to allow the machine to carry and disburse water from separate containment tanks if desired.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is:

1. A system comprising a dry material moving machine including:
a power unit connected to a positive air blower having
an air inlet;
and
an outlet in communication with a delivery line;
a dry media hopper including a feeder unit configured to direct dry material to the delivery line;
and
a hose reel associated with a hose,
wherein the delivery line is connected to the hose.

2. The system of claim 1, wherein the dry media hopper comprises a dry-material-feeding control valve.

3. The system of claim 2, wherein the dry-material-feeding control valve sits between the feeder unit and the delivery line.

4. The system of claim 3, wherein a tube connects the delivery line to the feeder unit and the dry-material-feeding unit, and the control valve is provided on the tube between the delivery line and the feeder unit.

5. The system of claim 1, wherein the power unit is one or combination of a gas engine, a diesel engine, and an electric motor.

6. The system of claim 5, wherein the power unit operates the positive air blower between 700 and 3000 RPM.

7. The system of claim 1, wherein the hose diameter is between 1 inch and 4 inches.

8. The system of claim 7, wherein the power unit is compatible with the diameter of the hose and is configured to deliver additional power as needed to supply and\or disperse sufficient dry material.

9. The system of claim 1 further comprising one or more storage hoppers.

10. The system of claim 1, a maximum line pressure of the delivery line is 25 psi.

11. The system of claim 1, further including a material crushing mechanism.

12. The system of claim 1, wherein the dry media hopper includes a cover.

13. The system of claim 1, wherein the delivery line is rigid.

14. The system of claim 13, wherein the delivery line has a diameter greater than or equal to 1 inch.

15. The system of claim 1, wherein the system is portable.

16. The system of claim 15, wherein the system mounts to a trailer or other transport means.

17. The system of claim 1, wherein the system is stationary.

18. The system of claim 1, wherein the dry material is on-site dirt.

19. The system of claim 1, wherein the dry material includes dry chemicals.

20. A system comprising:
a power unit connected to a positive air blower having
an air inlet;
and
an outlet in communication with a delivery line;
a dry media hopper including a feeder unit configured to direct dry material to the delivery line and a dry-material-feeding control valve;
and
a hose reel associated with a hose,
wherein the delivery line is connected to the hose;
wherein the dry-material-feeding control valve sits between the feeder unit and the delivery line;
wherein a tube connects the delivery line to the feeder unit and the dry-material-feeding control valve is provided on the tube between the delivery line and the feeder unit;
wherein the power unit is one or combination of a gas engine, a diesel engine, and an electric motor;
wherein the power unit operates the positive air blower between 700 and 3000 RPM;
wherein the hose diameter is between 1 inch and 4 inches;
wherein the power unit is compatible with the diameter of the hose and is configured to deliver additional power as needed to supply sufficient the dry material;
wherein a maximum line pressure of the delivery line is 25 psi;
wherein the system further includes a material crushing mechanism;
wherein the dry media hopper includes a cover;
wherein the delivery line is rigid;
wherein the delivery line has a diameter greater than or equal to 1 inch;
wherein the system is portable;
wherein the dry material is on-site dirt; and
wherein the dry material includes dry chemicals.
